(19) United States
(12) Patent Application Publication
(10) Pub. No.: US 2006/0103969 A1
(43) Pub. Date: May 18, 2006

(54) System and apparatus for position error signal linearization

(75) Inventors: Sang-Hoon Chu, San Jose, CA (US); Young-Hoon Kim, Santa Clara, CA (US); Cheol Hoon Park, San Jose, CA (US); Kang Seok Lee, San Jose, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd.

(21) Appl. No.: 10/987,044

(22) Filed: Nov. 12, 2004

(51) Int. Cl. G11B 5/596; G11B 5/55

(52) U.S. Cl. 360/77.02; 360/78.02

(57) ABSTRACT

A hard disk drive that utilizes a plurality of integrated gain compensation values to correct a non-linear position error signal (PES) function of the drive. The gain compensation values are generated, integrated and stored during an initial burn-in process of the drive. The PES is used in a servo loop to position a head relative to a track of a disk. The PES may have a non-linear function such that the signal is not representative of the actual position of the head. The integrated gain compensation values are used to correct the non-linear function so that the PES more accurately reflects the position of the head relative to the track.

### BACKGROUND OF THE INVENTION

1. Field of the Invention

The present invention relates to a method for correcting a non-linear position error signal function used to position a head relative to a disk of a hard disk drive.

2. Background Information

Hard disk drives contain a plurality of magnetic heads that are coupled to rotating disks. The heads can magnetize and sense the magnetic fields of the disk to write and read data, respectively. The heads are coupled to a pivoting actuator arm that has a voice coil motor.

Data is typically stored on tracks that extend radially across the disk surfaces. The voice coil motor can be energized to pivot the actuator arm and move the heads to different track locations. Each track is typically divided into a number of sectors. Each sector contains at least one data field.

Each track may also contain a plurality of servo fields. Each servo field may contain a number of servo bits that are read by the heads to determine the head position relative to the center of the track. It is desirable to center the head relative to the track when writing and/or reading data.

Most hard disk drives contain a servo loop that utilizes the servo bits to generate a position error signal (PES). The PES is used in the servo loop to move the head to a desired position relative to the track centerline. The PES is ideally a linear function of the actual displacement between the head and the center of the track. It has been found that magneto-resistive (MR) heads will generate a non-linear PES function. Consequently, the PES does not truly represent the actual displacement of the head relative to the track. FIG. 1 shows the difference between an ideal linear function and a typical non-linear function generated by MR heads. A non-linear PES function degrades the accuracy of the head location relative to the track. It would be desirable to provide a hard disk drive that compensates for a non-linear PES function.

### BRIEF SUMMARY OF THE INVENTION

A hard disk drive with a memory that contains a plurality of integrated gain compensation values. The integrated gain compensation values are used to position a head relative to a disk of the drive.

### BRIEF DESCRIPTION OF THE DRAWINGS

FIG. 1 is a graph showing a linear PES function and a non-linear function;

FIG. 2 is a top view of an embodiment of a hard disk drive;

FIG. 3 is a schematic of an electrical circuit for the hard disk drive;

FIG. 4 is a graph showing a correlation between an actual derivative of a PES function f(x) and a numerical derivative;

FIG. 5 is a graph showing a correlation between the functions 1/g(x) and 1/f(x);

FIG. 6 is a graph showing a corrected PES function;

FIG. 7 is a flowchart showing the generation and use of a correction function for a non-linear PES function.

### DETAILED DESCRIPTION

Disclosed is a hard disk drive that utilizes a plurality of integrated gain compensation values to correct a non-linear position error signal (PES) function of the drive. The gain compensation values are generated, integrated and stored during an initial burn-in process of the drive. The PES is used in a servo loop to position a head relative to a track of a disk. The PES may have a non-linear function so that the signal does not correlate with the actual position of the head. The integrated gain compensation values are used to correct the non-linear function so that the PES more accurately reflects the position of the head relative to the track.

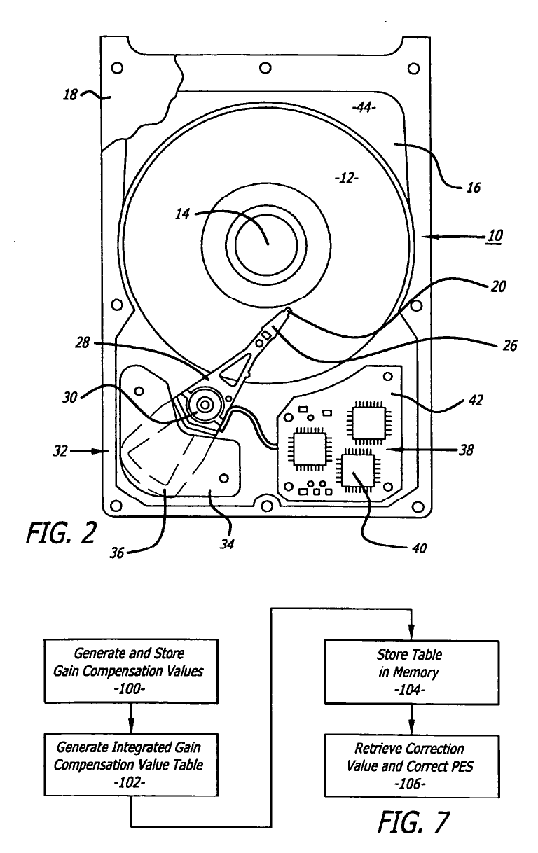

Referring to the drawings more particularly by reference numbers, FIG. 2 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write (not shown) and read elements (not shown). The heads 20 are gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

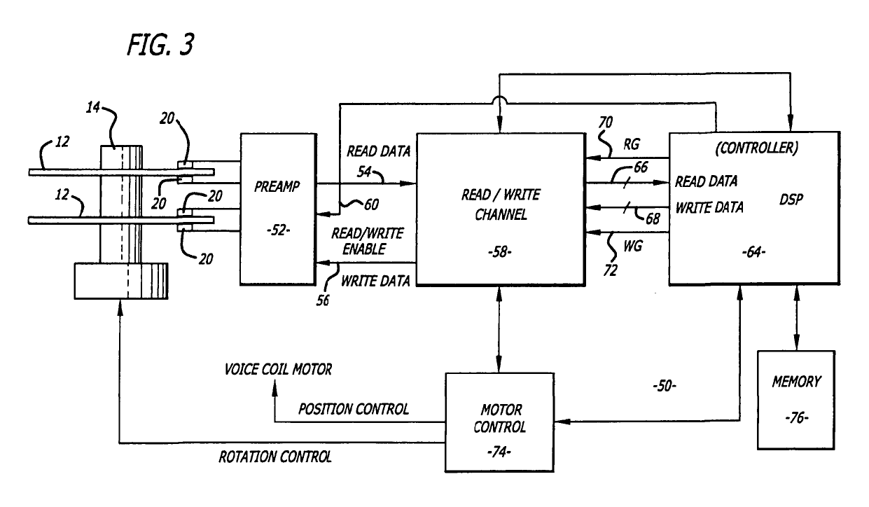

FIG. 3 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a firmware and/or software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”). The non-volatile memory 76 may contain the firmware and/or software performed by the controller 64.

The controller 64 energizes the voice coil motor 36 and move the heads 20 in accordance with a servo loop. The servo loop includes reading a servo field(s) of a disk 12 and generating a position error signal. The servo loop will also include a gain block that compensates for open loop gain variations relative to the radial location of the heads 20 relative to the disk 12. The gain block has a gain that varies as a function of the radial position of the heads. This is known as the gain function g(x). The variation in gain is compensated by gain compensation values. The gain compensation values are actually the inverse of the gain. The gain compensation values are therefore 1/g(x). The use and design of open loop servo gain blocks are known in the art.

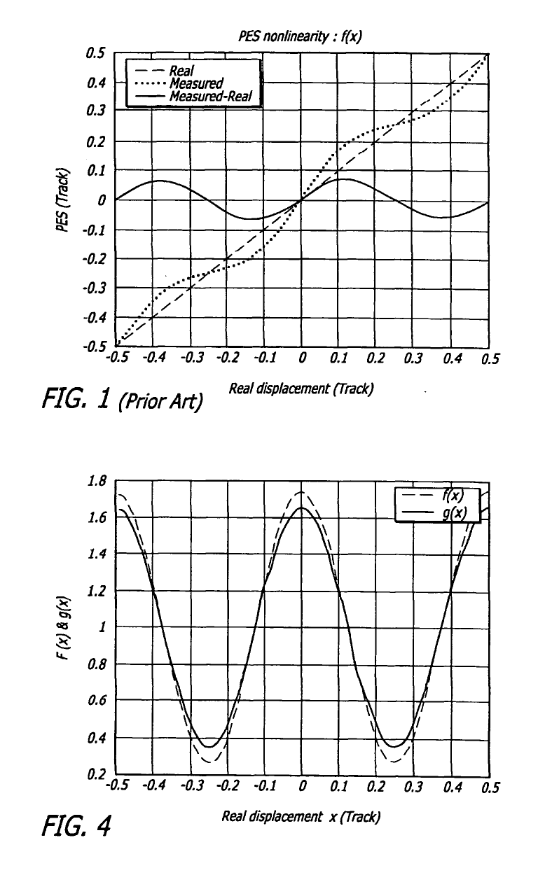

As shown in FIG. 1 the actual PES function is typically a non-linear function. It would be desirable to correct the non-linear function to achieve an essentially linear characteristic. The non-linear function can be corrected with an inverse of the non-linear function. One way to obtain the inverse of the PES function is to measure the actual head positions. This can be done with a servo writer. Such an approach would decrease the efficiency of writing servo into the disk drive.

Another approach is to correlate the inverse PES function with an integration of the gain compensation values from the serve gain block. This approach is based on an assumption that the gain function g(x) is approximately equal to the derivative of the PES function f(x). A plot of the actual derivative of f(x) and a numerical derivative of g(x) by a perturbation method is shown in FIG. 4. As shown in FIG. 4, the gain function g(x) does correlate to the derivative of the PES function f(x). The PES function could therefore theoretically be determined from the integral of g(x).

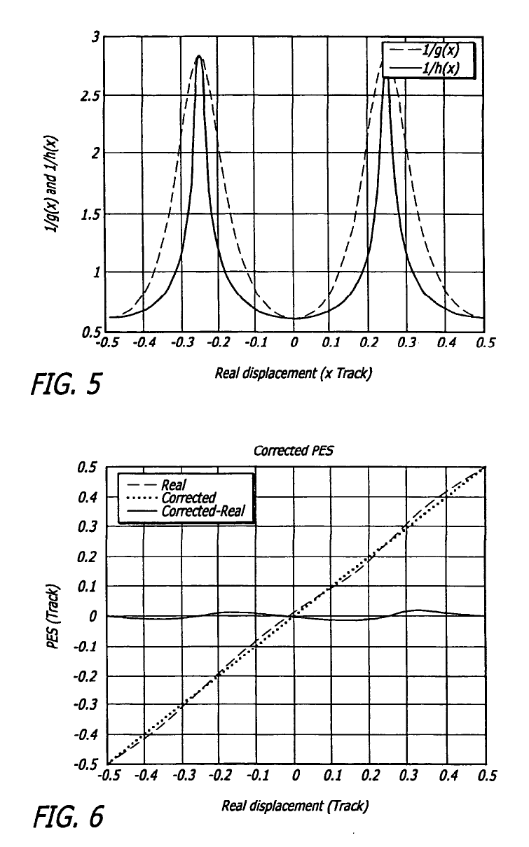

Unfortunately, the perturbation method actually produces a function h(x) that is approximately equal to g(f⁻¹(x)). FIG. 5 shows that the inverse of h(x), 1/h(x), correlates to 1/g(x). Therefore the inverse of the gain compensation function 1/g(x) can be approximated to 1/h(x). From this the inverse of the PES function f⁻¹(x) can be calculated from the integral of 1/h(x). The proof of this concept if provided by the following derivation.

Assume f(x) and f⁻¹(x) are differentiable.

Assume there exists positive constants m and M such that:
m≦f′(x)≦M (1)

By definition:
f(f⁻¹(x))=x (2)

differentiating both sides yields;
(f⁻¹)′(x)f′(f⁻¹(x))=1 (3)

which can be rearranged as:

$${( {f}^{- 1} )}^{′} ( x ) = \frac{1}{{f}^{′} ( {f}^{- 1} ( x ) )} = \frac{1}{h ( x )} \qquad ( 4 )$$

integrating both sides yields:

$${f}^{- 1} ( x ) = {\int }_{o}^{x} \frac{1}{h ( λ )} ⅆ λ \qquad ( 5 )$$

Thus the inverse correction function can be determined by integrating the gain compensation values. A correction value for any given point x can be generated by summing the gain compensation values for position 0 through x. An example, of a corrected PES function is shown in FIG. 6.

FIG. 7 shows a flowchart for generating and utilizing integrated compensation values to correct a non-linear PES function. The computation steps are typically performed by the controller 64. When the disk drive is initially burned-in the gain compensation values are generated and stored in memory in block 100.

The compensation values are generated from the gain block of the servo loop performed by the controller. In block 102 a table may be generated that contains an integration value for each head position of the drive. The integration values are the integrals for the gain compensation values generated for each position from position 0 to position x.

By way of example, if the head position is 5, then the integrated gain compensation value would be the sum of the gain compensation values generated in block 100 for positions 0, 1, 2, 3, 4 and 5. A different integrated gain compensation value is generated for each head position. Blocks 100 and 102 may occur simultaneously or in an otherwise time overlapping manner. For example, the integrated values may be calculated while the gain compensation values are being generated.

The integrated gain compensation value table is stored in memory in block 104. The table may be stored in memory 76, or on a disk 12. When the disk drive is operating the controller can read the table to obtain an integrated compensation value that is used to correct the PES for each head position in block 106. By way of example, the PES can be multiplied with the integrated gain compensation value.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a disk;
a spindle motor that rotates said disk;
a head coupled to said disk;
an actuator arm coupled to said head;
a voice coil motor coupled to said actuator arm;
a memory that contains a plurality of integrated gain compensation values derived from a head position servo loop; and,
a controller that is coupled to said head and said voice coil motor, said controller utilizes said integrated gain compensation values to position said head relative to said disk.

2. The disk drive of claim 1, wherein said memory is a non-volatile memory device.

3. The disk drive of claim 1, wherein said memory is part of said disk.

4. The disk drive of claim 1, wherein said integrated gain compensation values are used to correct a non-linear position error signal function.

5. The disk drive of claim 4, wherein said non-linear position error signal function is multiplied by said integrated compensation values.

6. A hard disk drive, comprising:
a disk;
a spindle motor that rotates said disk;
a head coupled to said disk;
an actuator arm coupled to said head;
a voice coil motor coupled to said actuator arm;
memory means for storing a plurality of integrated gain compensation values derived from a head position servo loop; and,
controller means for positioning said head relative to said disk using said integrated gain compensation values.

7. The disk drive of claim 6, wherein said memory means is a non-volatile memory device.

8. The disk drive of claim 6, wherein said memory means is part of said disk.

9. The disk drive of claim 6, wherein said integrated gain compensation values are used to correct a non-linear position error signal function.

10. The disk drive of claim 9, wherein said non-linear position error signal function is multiplied by said integrated compensation values.

11. A hard disk drive, comprising:
a disk;
a spindle motor that rotates said disk;
a head coupled to said disk;
an actuator arm coupled to said head;
a voice coil motor coupled to said actuator arm;
a controller coupled to said head and said voice coil motor;
a first memory that contains a plurality of integrated gain compensation values derived from a head position servo loop; and,
a second memory that contains a program that causes said controller to utilize said integrated gain compensation values to position said head relative to said disk.

12. The disk drive of claim 11, wherein said first and second memory are within a non-volatile memory device.

13. The disk drive of claim 11, wherein said first memory is part of said disk.

14. The disk drive of claim 11, wherein said integrated gain compensation values are used to correct a non-linear position error signal function.

15. The disk drive of claim 14, wherein said non-linear position error signal function is multiplied by said integrated compensation values.

16. A method for positioning a head relative to a disk of a hard disk drive, comprising:
reading a servo field of a disk with a head;
generating a position error signal from the read servo field;
correcting the position error signal with an integrated gain compensation value; and,
moving the head in accordance with the corrected position error signal.

17. A method for storing a plurality of integrated gain compensation values that are used to position a head relative to a disk of a hard disk drive, comprising:
moving a head across a disk along a plurality of head positions;
generating a gain compensation value for each head position;
integrating the gain compensation values for each head position; and,
storing the integrated gain compensation values.

18. The method of claim 17, wherein the integrated gain compensation values are utilized to correct a non-linear position error signal function.

19. The method of claim 17, wherein said integrated gain compensation values are stored in a look-up table.
